(19) United States
(12) Patent Application Publication
(10) Pub. No.: US 2005/0157525 A1
(43) Pub. Date: Jul. 21, 2005

(54) Dual AC and DC input DC power supply

(76) Inventor: George E. Hanson, Andover, KS (US)

Correspondence Address: LSI LOGIC CORPORATION, 1621 BARBER LANE, MS: D-106, MILPITAS, CA, 95035, US

(21) Appl. No.: 10/760,440

(22) Filed: Jan. 20, 2004

(51) Int. Cl. H02M 1/00

(52) U.S. Cl. 363/65

(57) ABSTRACT

A dual AC and DC input DC power supply is provided according to an embodiment of the invention. The power supply includes a DC output stage that outputs a predetermined DC electrical power and an AC input stage connected to the DC output stage. The AC input stage is configured to convert AC electrical power at the AC input stage into the predetermined DC electrical power available at the DC output stage. The power supply further includes a DC input stage connected to the DC output stage. The DC input stage is configured to convert DC electrical power at the DC input stage into the predetermined DC electrical power available at the DC output stage.

### BACKGROUND OF THE INVENTION

1. Field of the Invention

The invention is related to a power supply, and more specifically, to a DC power supply including an AC power input and a DC power input.

2. Description of Related Art

A power supply is a common component of many electronic devices. A power supply typically receives electrical power from a first source of electrical power and converts the electrical power into a proper voltage level and current capacity for an end application electronic device.

One electronic device that commonly employs a power supply is a digital storage device. A digital storage device can comprise a magnetic or optical storage. A digital storage can also comprise a solid-state storage. Modern storage devices can further comprise multiple storage media grouped into a unit, such as a Redundant Array of Independent Disks (RAID) memory, for example. Such digital storage devices commonly require a Direct Current (DC) voltage supply for operation.

In the prior art, a digital storage device power supply commonly is designed to accept an Alternating Current (AC) voltage input. The AC voltage input can be a widely available AC 110 volt, 60 Hertz signal. The AC voltage is converted into a DC voltage by a full-wave rectifier, with the resulting DC voltage output being filtered and smoothed to obtain a relatively flat DC voltage level.

A drawback in the prior art power supply approach is that such a prior art power supply is designed for a single predefined AC input voltage. The prior art does not accommodate both AC and DC input voltages. For example, some telecommunications equipment is designed to operate on a unique power supply input of a negatively-biased DC voltage of about 48 volts. Design of new components for telecommunications equipment therefore may benefit from special power supplies, with the attendant need for engineering and certifying the proper voltage and current levels, overload protection, heating levels, etc., that commonly go into the design of a new electronic product.

### SUMMARY OF THE INVENTION

The invention helps solve the above problems. Advantageously, the invention enables use of either an AC power input or a DC power input. Further, the invention enables use of both an AC power input and a DC power input.

A dual AC and DC input DC power supply is provided according to an embodiment of the invention. The power supply comprises a DC output stage that outputs a predetermined DC electrical power and an AC input stage connected to the DC output stage. The AC input stage is configured to convert AC electrical power at the AC input stage into the predetermined DC electrical power available at the DC output stage. The power supply further comprises a DC input stage connected to the DC output stage. The DC input stage is configured to convert DC electrical power at the DC input stage into the predetermined DC electrical power available at the DC output stage.

A dual AC and DC input DC power supply is provided according to an embodiment of the invention. The power supply comprises a DC output stage that outputs a predetermined positively-biased DC electrical power and an AC input stage connected to the DC output stage. The AC input stage is configured to convert AC electrical power at the AC input stage into the predetermined positively-biased DC electrical power available at the DC output stage. The power supply further comprises a negative DC input stage connected to the DC output stage. The negative DC input stage is configured to convert negatively-biased DC electrical power at the negative DC input stage into the predetermined positively-biased DC electrical power available at the DC output stage.

A method of providing a predetermined DC electrical power in a dual AC and DC input DC power supply is provided according to an embodiment of the invention. The method comprises receiving an AC electrical power in an AC input stage, converting the AC electrical power into the predetermined DC electrical power, receiving a DC electrical power in a DC input stage, converting the DC electrical power into a substantially AC waveform of a first AC voltage level, transforming the substantially AC waveform to a second AC voltage level, and rectifying the substantially AC waveform into the predetermined DC electrical power.

### BRIEF DESCRIPTION OF THE DRAWINGS

The same reference number represents the same element on all drawings.

FIG. 1 is a diagram of a dual AC and DC input DC power supply according to an embodiment of the invention;

FIG. 2 is a diagram of the power supply according to another embodiment of the invention;

FIG. 3 is a diagram of a dual AC and DC input DC power supply according to yet another embodiment of the invention;

FIG. 4 is a diagram of a driver circuit according to an embodiment of the invention; and

FIG. 5 is a diagram of a secondary stage of the power supply according to an embodiment of the invention.

### DETAILED DESCRIPTION OF THE DRAWINGS

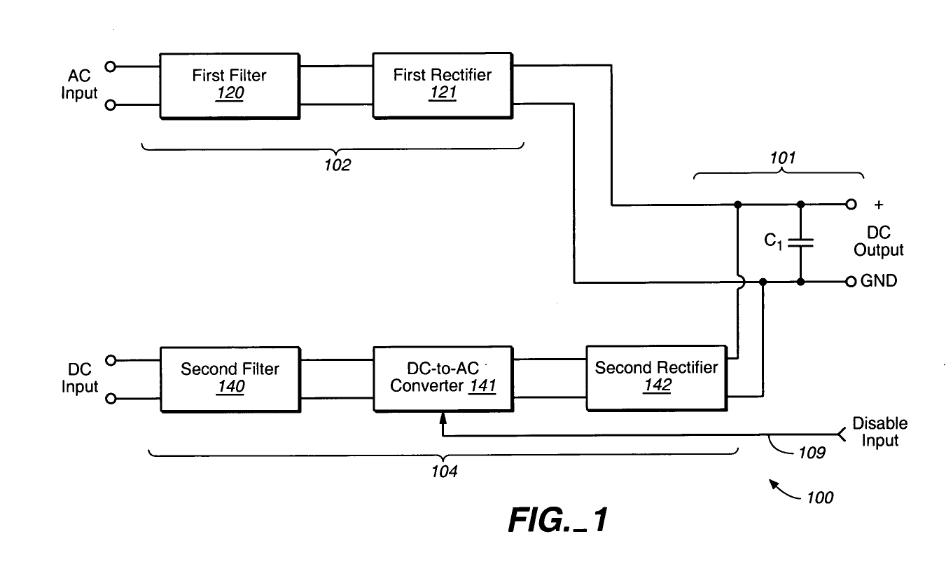

FIGS. 1-5 and the following descriptions depict specific embodiments to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will also appreciate that the features described below can be combined in various ways to form multiple variations of the invention. As a result, the invention is not limited to the specific embodiments described below, but only by the claims and their equivalents.

FIG. 1 is a diagram of a dual AC and DC input DC power supply 100 according to an embodiment of the invention. The power supply 100 includes a DC output stage 101, an AC input stage 102, and a DC input stage 104.

The power supply 100 can generate a predetermined DC electrical power at the DC output stage 101, with the predetermined DC electrical power being of predetermined DC voltage and current levels. In one embodiment, both the AC input stage 102 and the DC input stage 104 are connected to the DC output stage 101. The power supply 100 can therefore receive AC electrical power at the AC input stage 102 and can receive DC electrical power at the DC input stage 104. The power supply 100 can use either (or both) of the AC input stage 102 and the DC input stage 104 in order to generate the predetermined DC electrical power at the DC output stage 101.

The DC output stage 101 comprises a pair of DC output terminals. The DC output stage 101 can provide the predetermined DC electrical power comprising a positive DC voltage to ground voltage potential output (+V to ground, shown). The DC output stage 101 can therefore provide a positively-biased DC electrical power. Alternatively, the DC output stage 101 can provide a positive DC voltage to a negative DC voltage potential (+V to −V, not shown).

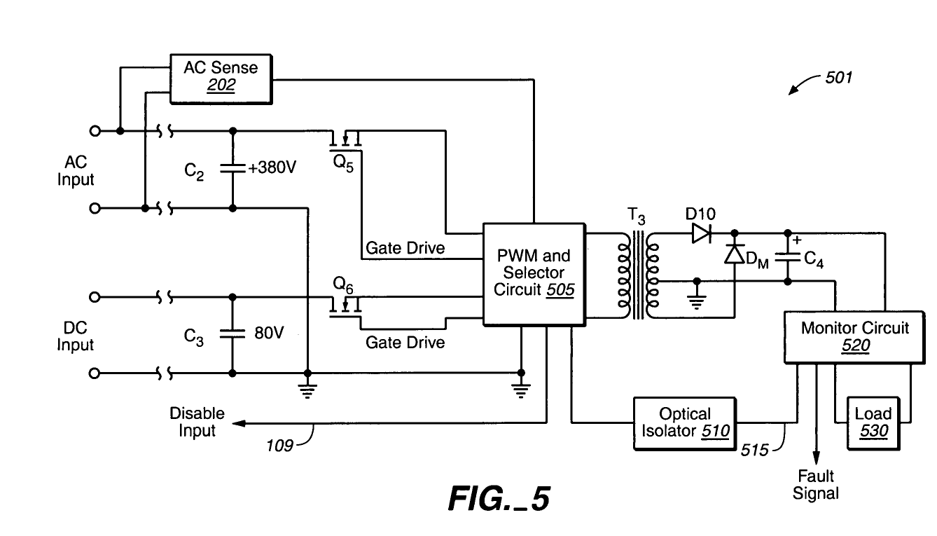

The DC output stage 101 in one embodiment comprises at least one capacitor C1. The DC output stage 101 can at least partially store electrical energy by charging the at least one capacitor C1 and can provide electrical energy to an electronic device or component connected to the pair of DC output terminals. The charging and discharging cycles of the at least one capacitor C1 functions to reduce or remove the AC ripple remaining on the output from the full-wave rectification. In another embodiment, the DC output stage 101 can comprise multiple pairs of output terminals and multiple capacitors (see FIG. 5).

The AC input stage 102 receives an AC input voltage through a pair of AC input terminals. In one embodiment, the AC input voltage comprises an AC voltage at about 110-115 volts (V) and having a frequency of about 60 Hertz (Hz). It should be understood that the AC input stage 102 can receive an AC input voltage having other voltage levels and other frequencies, such as a European voltage of 220 V at 50 Hz, for example. In some embodiments, the AC input stage 102 can accept an AC input of about 90 to about 264 V and having a frequency of about 50 to about 60 Hertz. However, it is anticipated that other voltages and frequencies can be employed, and therefore fall within the scope of the claims.

In the embodiment shown, the AC input stage 102 comprises a first filter 120 and a first rectifier 121. The first filter 120 can comprise one or more filters configured to remove noise or unwanted signals from the AC input voltage. The first filter 120 can comprise any manner and number of filters or filter networks capable of filtering the AC input electrical power. The first filter 120 can include active and passive filter networks. In addition, the first filter 120 can perform AC power factor correction.

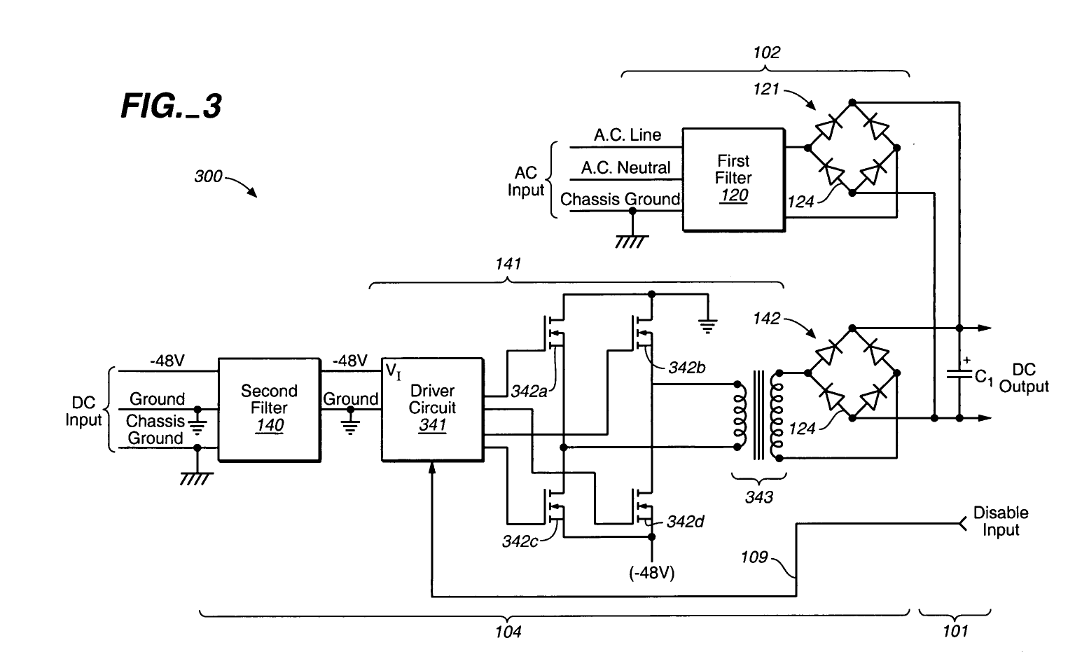

The first rectifier 121 converts the AC voltage into a substantially DC voltage. For example, in one embodiment the first rectifier 121 comprises a full-wave bridge rectifier circuit that passes a positive-swing component and inverts a negative-swing component of the AC input voltage into a positive-swing half-wave component (see the bridge circuit 121 in FIG. 3). It should be understood that the AC input stage 102 can comprise alternative or additional components, and such components are within the scope of the description and accompanying claims.

The DC input stage 104 receives a DC input voltage through a pair of DC input terminals. The DC input stage 104 receives an input DC voltage and converts it into the predetermined DC electrical power. The DC input stage 104 transforms a DC input voltage into a DC output voltage by converting the DC electrical power into a substantially AC waveform of a first AC voltage level, transforming the substantially AC waveform to a second AC voltage level, and rectifying the substantially AC waveform into the predetermined DC electrical power.

It should be understood that the substantially AC waveform is not a perfect sinusoid, and instead comprises essentially a square wave pulse train having alternating positive and negative voltages. The square wave pulse train may exhibit some rounding of leading and trailing edges due to the frequency response characteristics of components of the DC input stage 104.

The DC input voltage can comprise a positive DC voltage to ground voltage potential (+V to ground), or can comprise a positive DC voltage to a negative DC voltage potential (+V to −V). Alternatively, the DC input stage 104 can comprise a negative DC input stage and the DC input voltage can comprise a negatively-biased DC electrical power in the form of a negative DC voltage to ground voltage potential (−V to ground). In one embodiment, the DC input voltage comprises a negative (−) 48V telecommunications supply voltage potential commonly used in telecommunications devices or telecommunications systems.

In the embodiment shown, the DC input stage 104 comprises a second filter 140, a DC-to-AC converter 141, and a second rectifier 142. The second filter 140 can comprise one or more filters configured to remove noise or unwanted signals from the DC input voltage. The second filter 140 can comprise any manner and number of filters or filter networks capable of filtering the DC input electrical power. The second filter 140 can include active and passive filter networks.

The DC-to-AC converter 141 is configured to generate a substantially AC waveform from the DC electrical power. The substantially AC waveform is generated at a first AC voltage level. The DC-to-AC converter 141 can comprise a switching circuit having a typical AC cycle time, wherein the DC-to-AC converter 141 generates the substantially AC waveform (see FIG. 3 and the accompanying text). The DC-to-AC converter 141 can further comprise a step-up transformer that increases the voltage swing of the substantially AC waveform. Alternatively, the DC-to-AC converter 141 can further comprise a step-down transformer that decreases the voltage swing of the substantially AC waveform. In another alternative embodiment, the DC-to-AC converter 141 can further comprise an isolation transformer that increases the drive current of the substantially AC waveform. It should be understood that the DC-to-AC converter 141 can include alternate or additional components, and such components are within the scope of the description and accompanying claims. The second rectifier 142 converts the substantially AC waveform into a substantially DC voltage (i.e., into the predetermined DC output voltage), as previously discussed.

The DC input stage 104 can further include a disable input 109 that can be used to disable outputting the predetermined DC electrical power from the DC input stage 104. The disable input 109 can be connected to a monitor circuit, processor, or load device (not shown) located after the DC output stage 101. The disable input 109 can be used to select or de-select the DC input electrical power. If only the DC input is being used, the disable input 109 can be used to power the power supply 100 on and off by toggling the disable input 109.

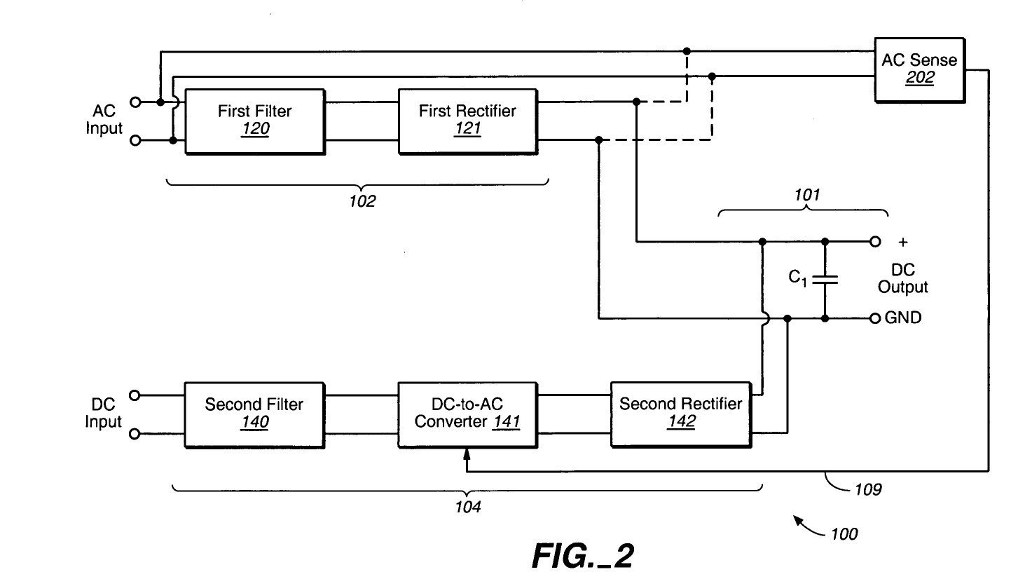

FIG. 2 is a diagram of the power supply 100 according to another embodiment of the invention. In this embodiment, the power supply 100 includes the disable input 109 and an AC sense 202 connected to the disable input 109. The AC sense 202 senses whether AC electrical power is present in the AC input stage 102 and can disable the outputting of the predetermined DC electrical power from the DC input stage 104. Therefore, in one embodiment, the power supply 100 can autonomously enable the DC input stage 104 when the AC sense 202 detects an absence of AC electrical power at the AC input stage 102. Alternatively, the power supply 100 can comprise an uninterruptible power supply and the DC input stage 104 could be connected to some manner of battery or battery array in anticipation of an AC power loss. In one embodiment, the AC sense 202 comprises a MID400 power line monitor integrated circuit. However, other integrated circuits or circuit configurations can be used to implement the AC sense 202.

In one embodiment, the AC sense 202 can be connected to the AC input stage 102 before the first rectifier 121, wherein the AC sense detects the AC electrical power (solid lines). Alternatively, the AC sense is connected to the output of the first rectifier 121 and generates a signal if DC electrical power is present at the first rectifier 121 as a result of AC electrical power being present at the AC input (dashed lines).

FIG. 3 is a diagram of a dual AC and DC input DC power supply 300 according to an embodiment of the invention. The power supply 300 includes the DC output stage 101, the AC input stage 102, and the DC input stage 104. In this embodiment, chassis ground lines could also be used for safety reasons and for operation of the first and second filters 120 and 140. In addition, the connectors for the AC inputs and the DC inputs and outputs can be selected according to equipment requirements and safety regulations.

As previously discussed, the AC input stage 102 comprises the first filter 120 and the first rectifier 121. The first rectifier 121 comprises four diodes 124 connected in a full-wave bridge rectifier configuration. In one embodiment, the diodes 124 comprise fast recovery silicon diodes.

As previously discussed, the DC input stage 104 comprises the second filter 140, the DC-to-AC converter 141, and the second rectifier 142. The second rectifier 142 comprises four diodes 124 connected in a full-wave bridge rectifier configuration, as previously discussed.

In the embodiment shown, the DC-to-AC converter 141 comprises a driver circuit 341 connected to the second filter 140, transistors 342 connected to the driver circuit 341, and a transformer 343 connected to the transistors 342. The transformer 343 is further connected to the second rectifier 142.

The driver circuit 341 is configured to generate a substantially AC waveform from the DC electrical power. The substantially AC waveform is generated at a first AC voltage level. The substantially AC waveform is produced by fully reversing the field provided to the primary windings of the transformer 343 through an H-pattern bridge that transmits both positive and negative waveform portions to the primary windings. This doubles the available voltage and reduces the transformer turns ratio needed to provide the necessary peak-to-peak AC voltage. Since energy on a capacitor is directly proportional to the square of the voltage, doubling the effective voltage achieves the effect of moving energy to the capacitor four times as rapidly as if the input voltage were simply chopped into a square wave.

The substantially AC waveform generated by the driver circuit 341 is provided to a circuit comprising four transistors 342 configured as the H-pattern bridge. The driver circuit 341 in one embodiment level-shifts its output voltage to where it can adequately drive the gates on the transistors 342. The transistors 342 provide current to the substantially AC waveform. The transistors 342 can comprise Field Effect Transistors (FETs), as shown, although other transistors or current buffering devices can alternatively be employed.

The driver circuit 341 typically operates in the kilohertz to tens of kilohertz range. As a result, the transformer 343 can comprise a torroid or ferrite cup type of transformer. Because the input to the transformer 343 is not a pure sinusoid, the input pulse train will be composed of harmonic frequencies, possibly up into the 100,000 to 1,000,000 Hertz range. Therefore, if the transformer 343 can pass these high frequencies, the DC input stage 104 can more efficiently provide energy to the DC output stage 101.

The ratio of the number of turns in the primary and secondary windings of the transformer 343 is determined by the desired DC voltage level of the predetermined DC electrical power at the DC output stage 101. Since the driving waveform output by the driver circuit 341 can comprise a bipolar square wave, it is desirable to operate at the highest frequency possible and to minimize the time that the voltage is not changing. Circuit capacitances, resistances, and inductances will serve to round the edges of the waveform and approximate the exponential charge and decay cycles that are efficiently transmitted by the transformer 343. This simulates a substantially sine wave input to the transformer 343.

In operation, the driver circuit 341 switches a first waveform half to a first pair of transistors 342, such as to transistors 342a and 342d. As a result, current flows from the ground node through transistor 342a, through the primary of the transformer 343, through the transistor 342d, and into the −48V supply node. During the next waveform half cycle, the driver circuit 341 switches the second waveform half to the transistors 342c and 342b. The transistors 342 buffer the driver circuit 341 from the transformer 343 and provide drive current to the waveform. The buffered waveform is applied across the primary windings of the transformer 343.

The transformer 343 can be used for electrical isolation of the waveform. In addition, the transformer 343 can be used to step-up or step-down the voltage of the substantially AC waveform, depending on the desired voltage level of the DC output voltage. For example, in one embodiment the DC-to-AC converter 141 can generate a substantially AC waveform in excess of 600 volts AC, where a DC output voltage of +380 V is desired. The DC-to-AC conversion allows the low input DC voltage to be transformed to the desired end DC voltage.

The secondary windings of the transformer 343 are connected to the second rectifier 142. The second rectifier 142 converts the AC waveform to DC and provides the predetermined DC electrical power to the DC output stage 101.

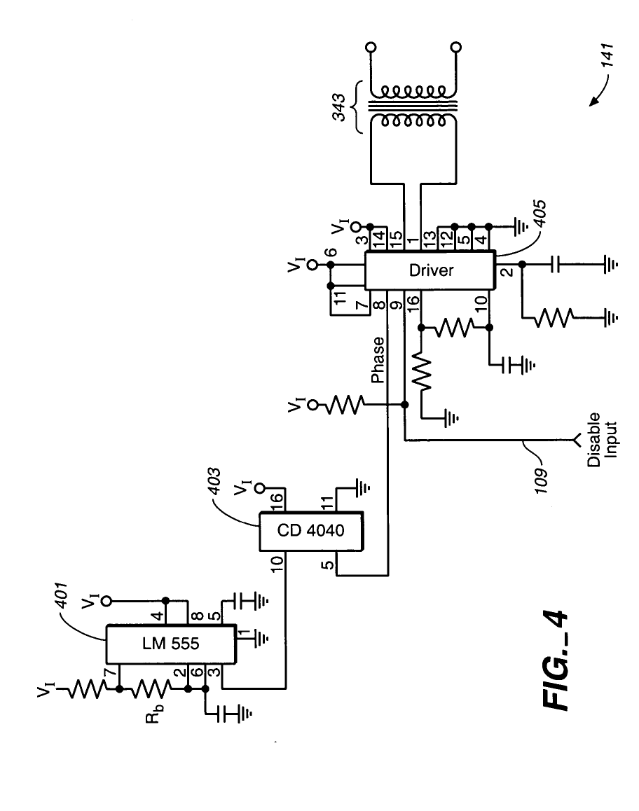

FIG. 4 is a diagram of the DC-to-AC converter 141 according to an embodiment of the invention. The DC-to-AC converter 141 receives the DC input voltage VI and ground from the second filter 140 and outputs the substantially AC waveform to the second rectifier 142. The DC-to-AC converter 141 in one embodiment includes an oscillator 401, a counter 403, and a driver circuit 405.

The oscillator 401 generates a square wave output. In the embodiment shown, the oscillator 401 generates a substantially 50 percent duty cycle square wave pulse train having levels of zero volts and substantially the input voltage VI. The output frequency can be set by selection of the resistors Ra and Rb. The output frequency can be set at any desired frequency, with the AC waveform at the transformer 343 being any frequency that can pass through the transformer 343, including frequencies up into the kilohertz (kHz) range. In one embodiment, the oscillator 401 comprises a LM 555 oscillator/timer integrated circuit. However, other oscillator circuits and integrated circuits can be used.

The counter 403 counts the pulses generated by the oscillator 401 and can be configured to control and reduce the frequency of the square wave pulse train. For example, the counter 403 can divide the initial frequency of the oscillator square wave output by a factor of two, four, eight, sixteen, etc. The output of the counter 403 feeds into the driver circuit 405. However, depending on the output of the oscillator 401, the counter 403 may not be necessary. In addition, the counter 403 may be included in order to perform clock dithering to spread radiated noise over wider bandwidth segments.

In one embodiment, the counter 403 comprises a CD4040 integrated circuit. However, other circuits or integrated circuits can be used to implement a counter. In addition, it should be understood that the oscillator 401 and the counter 403 can be implemented by an equivalent circuit that generates a substantially AC waveform to the driver circuit 405.

The driver circuit 405 is configured to generate positive and negative pulses across a selected pair of output pins in order to drive an electromagnetic coil. Pins 1 and 15 in the figure are one such pair of output pins. The driver circuit 405 receives the output of the oscillator 401/counter 403 as a square wave at a phase input pin. The zero and +V voltage levels of the square wave cause the driver circuit 405 to generate corresponding positive and negative voltage levels or pulses. The output of the driver circuit 405 can be enabled and disabled by the disable input 109, as previously discussed. The output waveform can be connected directly to the transformer 343. The function performed by driver circuit 405 is analogous to that of a stepper driver motor such as a UC3717A stepper motor drive integrated circuit that includes an H-bridge output stage. In preferred embodiments hereof, where higher power is required of the driver circuits 405, custom discrete components performing similar functions at higher power levels would be provided. Alternatively, the output waveform can be connected to the transformer 343 through a buffer stage, as previously discussed.

FIG. 5 is a diagram of a secondary stage 501 of the power supply 100 according to an embodiment of the invention. It should be understood that the secondary stage 501 can be of any configuration. The secondary stage 501 in the embodiment shown is connected to the DC output stage 101 and draws electrical power therefrom. The secondary stage 501 includes a capacitor C2 that receives a first predetermined DC electrical power from the AC input stage 102 and a capacitor C3 that receives DC electrical power from the DC input stage 104. The first predetermined electrical power can comprise a first DC voltage level and the second predetermined electrical power can comprise a second DC voltage level. The first and second predetermined DC voltage levels can comprise different voltage levels or can comprise substantially the same voltage levels. In the embodiment shown, the first DC voltage level is about +380V and the second DC voltage level is about +80V.

The output of capacitor C2 can be selectively inputted into the Pulse Width Modulation (PWM) circuit 505 by the transistor Q5. In addition, the output of capacitor C3 can be selectively inputted into the PWM circuit 505 by the transistor Q6. The input voltage level supplied to the PWM circuit 505 can therefore be selected by the PWM circuit 505. The transistors Q5 and Q6 in one embodiment comprise FETs.

The PWM circuit 505 generates a PWM pulse train to the transformer T3, with the amplitude of the pulse train being selected to be either substantially the first predetermined DC voltage level or substantially the second predetermined DC voltage level. The PWM circuit 505 can also receive the AC sense output from the AC sense 202 and generate the disable input 109 from the AC sense output. The PWM pulse train is transmitted through transformer T3 and is rectified by a full-wave rectifier comprising the diodes D1 and D11. The final DC voltage is placed across the capacitor C4 and the monitor circuit 520.

The monitor circuit 520 can perform monitoring functions for the final DC output voltage. For example, the monitor circuit 520 can perform current sensing, DC filtration, voltage sensing, and remote sensing of conditions at the load 530. In addition, the monitor circuit 520 can perform fault detection, such as a short or break in the circuit to the load 530. Furthermore, the monitor circuit 520 can generate a fault signal. In addition, the monitor circuit 520 can generate a feedback signal or feedback messages to the PWM circuit 505 over a feedback line 515. The feedback line 515 can include an optical isolator 510 that electrically isolates the monitor circuit 520 from the PWM circuit 505. The monitoring circuit in this embodiment delivers the final DC voltage output to the load 530.

The dual AC and DC input DC power supply 100 according to the invention can be implemented according to any of the embodiments in order to obtain several advantages, if desired. The dual AC and DC input DC power supply 100 according to the invention can operate from either an AC input voltage or from a DC input voltage. The dual AC and DC input DC power supply 100 can autonomously switch between input voltages if the AC input voltage ceases. The dual AC and DC input DC power supply 100 can operate from a telecommunications standard negative DC input voltage.

1. A dual AC and DC input DC power supply, comprising:
a DC output stage that outputs a predetermined DC electrical power;
an AC input stage connected to the DC output stage, with the AC input stage configured to convert AC electrical power at the AC input stage into the predetermined DC electrical power available at the DC output stage; and
a DC input stage connected to the DC output stage, with the DC input stage configured to convert DC electrical power at the DC input stage into the predetermined DC electrical power available at the DC output stage.

2. The power supply of claim 1, wherein the DC electrical power at the DC input stage comprises a negatively-biased DC electrical power.

3. The power supply of claim 1, wherein the DC output stage comprises at least one capacitor across a DC positive output terminal and a DC ground output terminal.

4. The power supply of claim 1, wherein the DC input stage comprises a DC input stage disable line that disables outputting the predetermined DC electrical power from the DC input stage.

5. The power supply of claim 1, wherein the power supply further comprises an AC sense circuit that detects AC electrical power at the AC input stage and wherein the DC input stage comprises a DC input stage disable line connected to the AC sense circuit, and wherein the DC input stage disable line disables outputting the predetermined DC electrical power from the DC input stage when the AC sense circuit detects AC electrical power at the AC input stage.

6. The power supply of claim 1, wherein the power supply further comprises an AC sense circuit that detects AC electrical power at the AC input stage and wherein the DC input stage comprises a DC input stage disable line connected to the AC sense circuit, and wherein the power supply autonomously enables the DC input stage when the AC sense circuit detects an absence of AC electrical power at the AC input stage.

7. The power supply of claim 1, with the DC input stage comprising:
a switching circuit that receives the DC electrical power and that is configured to generate a substantially AC waveform at a first AC voltage level from the DC electrical power;
a transformer connected to the switching circuit and configured to convert the substantially AC waveform at the first AC voltage level to a second AC voltage level; and
a full-wave rectifier connected to the transformer and configured to convert the substantially AC waveform at the second AC voltage level to the predetermined DC electrical power.

8. The power supply of claim 1, with the DC input stage comprising:
a switching stage that receives the DC electrical power and that is configured to generate a substantially AC waveform at a first AC voltage level from the DC electrical power;
a buffer stage connected to the switching circuit and configured to provide electrical current to the substantially AC waveform;
a transformer connected to the buffer stage and configured to convert the substantially AC waveform at the first AC voltage level to a second AC voltage level; and
a full-wave rectifier connected to the transformer and configured to convert the substantially AC waveform at the second AC voltage level to the predetermined DC electrical power.

9. The power supply of claim 8, wherein the buffer stage comprises field-effect transistors (FETs) connected in an H-bridge configuration.

10. A dual AC and DC input DC power supply, comprising:
a DC output stage that outputs a predetermined positively-biased DC electrical power;
an AC input stage connected to the DC output stage, with the AC input stage configured to convert AC electrical power at the AC input stage into the predetermined positively-biased DC electrical power available at the DC output stage; and
a negative DC input stage connected to the DC output stage, with the negative DC input stage configured to convert negatively-biased DC electrical power at the negative DC input stage into the predetermined positively-biased DC electrical power available at the DC output stage.

11. The power supply of claim 10, wherein the DC output stage comprises at least one capacitor across a DC positive output terminal and a DC ground output terminal.

12. The power supply of claim 10, wherein the DC input stage comprises a DC input stage disable line that disables outputting the predetermined positively-biased DC electrical power from the DC input stage.

13. The power supply of claim 10, wherein the power supply further comprises an AC sense circuit that detects AC electrical power at the AC input stage and wherein the DC input stage comprises a DC input stage disable line connected to the AC sense circuit, wherein the DC input stage disable line disables outputting the predetermined positively-biased DC electrical power from the DC input stage when the AC sense circuit detects AC electrical power at the AC input stage.

14. The power supply of claim 10, wherein the power supply further comprises an AC sense circuit that detects AC electrical power at the AC input stage and wherein the DC input stage comprises a DC input stage disable line connected to the AC sense circuit, and wherein the power supply autonomously enables the DC input stage when the AC sense circuit detects an absence of AC electrical power at the AC input stage.

15. The power supply of claim 10, with the DC input stage comprising:
a switching circuit that receives the negatively-biased DC electrical power and that is configured to generate a substantially AC waveform at a first AC voltage level from the negatively-biased DC electrical power;
a transformer connected to the switching circuit and configured to convert the substantially AC waveform at the first AC voltage level to a second AC voltage level; and
a full-wave rectifier connected to the transformer and configured to convert the substantially AC waveform at the second AC voltage level to the predetermined positively-biased DC electrical power.

16. The power supply of claim 10, with the DC input stage comprising:
a switching stage that receives the negatively-biased DC electrical power and that is configured to generate a substantially AC waveform at a first AC voltage level from the negatively-biased DC electrical power;
a buffer stage connected to the switching circuit and configured to provide electrical current to the substantially AC waveform;
a transformer connected to the buffer stage and configured to convert the substantially AC waveform at the first AC voltage level to a second AC voltage level; and
a full-wave rectifier connected to the transformer and configured to convert the substantially AC waveform at the second AC voltage level to the predetermined positively-biased DC electrical power.

17. The power supply of claim 16, wherein the buffer stage comprises field-effect transistors (FETs) connected in an H-bridge configuration.

18. A method of providing a predetermined DC electrical power in a dual AC and DC input DC power supply, the method comprising:
receiving an AC electrical power in an AC input stage;
converting the AC electrical power into the predetermined DC electrical power;
receiving a DC electrical power in a DC input stage;
converting the DC electrical power into a substantially AC waveform of a first AC voltage level;
transforming the substantially AC waveform to a second AC voltage level; and
rectifying the substantially AC waveform into the predetermined DC electrical power.

19. The method of claim 20, with the receiving the DC electrical power comprising receiving a negatively-biased DC electrical power and with the rectifying comprising rectifying the substantially AC waveform into a predetermined positively-biased DC electrical power.
